(19) United States
(12) Patent Application Publication
(10) Pub. No.: US 2021/0234231 A1
(43) Pub. Date: Jul. 29, 2021

(54) COAXIAL FIBER AND ELECTROCHEMICAL DEVICE INCLUDING SAME

(71) Applicant: NINGDE AMPEREX TECHNOLOGY LIMITED, Ningde City, Fujian Province (CN)

(72) Inventors: Yibo ZHANG, Ningde City, Fujian Province (CN); Bin WANG, Ningde City, Fujian Province (CN); Xiang LI, Ningde City, Fujian Province (CN); Ying SHAO, Ningde City, Fujian Province (CN)

(21) Appl. No.: 16/965,786

(22) PCT Filed: Mar. 27, 2020
(86) PCT No.: PCT/CN2020/081604

§ 371 Date: Jul. 29, 2020

(30) Foreign Application Priority Data
Mar. 29, 2019 (CN) 201910249012.0

(51) Int. Cl. H01M 50/44; H01M 50/449; H01M 10/0525; H01M 50/414; H01M 50/446; D01F 8/04; D01F 8/18

(52) U.S. Cl. CPC H01M 50/44; H01M 50/449; H01M 10/0525; D01F 8/18; H01M 50/446; D01F 8/04; H01M 50/414

(57) ABSTRACT

An electrochemical device including a coaxial fiber. The coaxial fiber includes a first fiber as a shell and a second fiber as a core, wherein the first fiber includes a polymer, and the second fiber includes a foamed material. The electrochemical device including the coaxial fiber has good overcharge resistance and abuse resistance.

### CROSS REFERENCE TO RELATED APPLICATIONS

The present application is a National Stage application of PCT international application: PCT/CN2020/081604, filed on 27 Mar. 2020, which claims the benefit of priority from the China Patent Application No. 201910249012.0, filed on 29 Mar. 2019, the disclosure of which is hereby incorporated by reference in its entirety.

### BACKGROUND

### 1. Technical Field

The present application relates to the field of electrochemistry, and more particularly to a coaxial fiber and an electrochemical device including the same.

### 2. Description of the Related Art

Lithium-ion batteries have many advantages, such as large volume energy is density and mass energy density, long cycle life, high nominal voltage, low self-discharge rate, small size and light weight, and have wide applications in the field of consumer electronics. In the existing lithium-ion battery system, the separator acts to ensure lithium ion conduction and to isolate electron conduction, and plays an important role in the lithium-ion battery. As demands for lithium-ion battery energy density increase, the separator needs to be made thinner and thinner However, it is difficult to make the conventional separator thinner while ensuring safety of the lithium-ion battery.

Therefore, a method of directly coating an insulating polymer on the surface of the electrodes of a lithium-ion battery as a separation layer between a cathode and an anode of the lithium-ion battery emerged, and this method can make the separation layer thinner, thereby enhancing the energy density of lithium-ion battery. However, the separation layer prepared by using this method has a very high porosity and does not have the characteristic of closed pores at a high temperature like a conventional separator, and thus has a large safety risk in the case of abuse such as overcharge and high temperature.

### SUMMARY

The present application provides a coaxial fiber and an electrochemical device including the same in an attempt to solve at least one of the technical problems that exist in the related art at least to some extent.

According to embodiments of the present application, the present application provides a coaxial fiber, including a first fiber as a shell and a second fiber as a core, wherein the first fiber includes a polymer, and the second fiber includes a foamed material.

According to embodiments of the present application, the foamed material includes a thermoplastic and a hydrocarbon having a boiling point of lower than 250° C., the thermoplastic being at least one selected from the group consisting of polyethylene terephthalate, polybutylene terephthalate, polyethylene naphthalate, polyimide, polyamide, polyetheretherketone, polymethacrylonitrile and polymethyl methacrylate ; and the hydrocarbon having a boiling point of lower than 250° C. being at least one selected from the group consisting of dibromomethane, ethylene carbonate, p-xylene, dimethylformamide and aniline

According to embodiments of the present application, the polymer is at least one selected from the group consisting of polyvinylidene fluoride, polyimide, polyamide, polyacrylonitrile, polyethylene glycol, polyoxyethylene, polyphenylene oxide, polypropylene carbonate, polymethyl methacrylate, polyethylene terephthalate, poly(ethylene oxide), a vinylidene fluoride-hexafluoropropylene copolymer, a vinylidene fluoride-trifluorochloroethylene copolymer and derivatives thereof

According to embodiments of the present application, the coaxial fiber has a diameter of about 20 nm-about 2 μm, and a ratio of a diameter of the second fiber to the diameter of the coaxial fiber is about 0.20-about 0.99.

According to embodiments of the present application, the hydrocarbon having a boiling point of lower than 250° C. is dispersed inside or on a surface of the thermoplastic, and the hydrocarbon having a boiling point of lower than 250° C. has a spherical shape, an ellipsoidal shape, a rod shape or an irregular polyhedron.

According to embodiments of the present application, the present application provides an electrochemical device, including: a cathode, an anode and a separation layer disposed between the cathode and the anode, where the separation layer includes any of the above coaxial fiber.

According to embodiments of the present application, at least one surface of the cathode and the anode is in contact with the separation layer.

According to embodiments of the present application, the separation layer has a thickness of about 1 μm-about 20 μm, and the separation layer has a porosity of about 30%-about 95%.

According to embodiments of the present application, the separation layer further includes inorganic particles, the inorganic particles being at least one selected from the group consisting of: (a) inorganic particles having a dielectric is constant of 5 or more; (b) inorganic particles having piezoelectricity; and (c) inorganic particles having lithium ion conductivity.

According to embodiments of the present application, further comprising an inorganic porous layer provided between the separation layer and the cathode or the anode, wherein, the inorganic porous layer is in contact with the separation layer, and the inorganic porous layer includes the above inorganic particles.

According to embodiments of the present application, the inorganic particles are at least one selected from the group consisting of: (a) inorganic particles having a dielectric constant of 5 or more; (b) inorganic particles having piezoelectricity; and (c) inorganic particles having lithium ion conductivity.

According to embodiments of the present application, the inorganic particles are the inorganic particles having the dielectric constant of 5 or more; the inorganic particles include at least one selected from the group consisting of BaO, SiO₂, SrTiO₃, SnO₂, CeO₂, MgO, NiO, CaO, ZnO, ZrO₂, Y₂O₃, Al₂O₃, TiO₂, boehmite, magnesium hydroxide, aluminum hydroxide, and SiC.

According to embodiments of the present application, the inorganic particles are the inorganic particles having piezoelectricity; the inorganic particles include at least one selected from the group consisting of BaTiO₃, Pb(Zr,Ti)O₃, Pb₁₋ₓLaₓZr_{1-y}TiyO₃ (0<x<1 and 0<y<1), Pb(Mg_{1/3}Nb_{2/3})O₃—PbTiO₃, and hafnium oxide.

According to embodiments of the present application, the inorganic particles are the inorganic particles having lithium ion conductivity; the inorganic particles include at least one selected from the group consisting of: lithium phosphate Li₃PO₄; lithium titanium phosphate LiₓTi_{y}(PO₄)₃, wherein 0<x<2, 0<y<3; lithium aluminum titanium phosphate LiₓAl_{y}Ti_{z}(PO₄)₃, wherein 0<x<2, 0<y<1, and 0<z<3; Li_{1+x+y}(Al, Ga)ₓ(Ti,Ge)₂₋ₓSi_{y}P_{3-y}O₁₂, wherein 0≤x≤1 and 0≤y≤1; (LiAlTiP)ₓO_{y} type glass, wherein 0<x<4 and 0<y<13; lithium lanthanum titanate LiₓLa_{y}TiO₃, wherein 0<x<2 and 0<y<3; lithium germanium thiophosphate LiₓGe_{y}P_{z}S_{w}, wherein 0<x<4, 0<y<1, and 0<z<1, 0<w<5; lithium nitride LiₓN_{y}, wherein 0<x<4 and 0<y<2; SiS₂ type glass LiₓSi_{y}S_{z}, wherein 0<x<3, 0<y<2, and 0<z<4; and P₂S₅ type glass LiₓP_{y}S_{z}, wherein 0<x<3, 0<y<3, and 0<z<7.

According to embodiments of the present application, the cathode and the anode each include a current collector, and at least one surface of the current collector is provided with a conductive coating.

Additional aspects and advantages of the embodiments of the present application will be described or shown in the following description or interpreted by implementing the embodiments of the present application.

### BRIEF DESCRIPTION OF THE DRAWINGS

The following will briefly illustrate the accompanying drawings necessary to describe the embodiments of the present application or the prior art so as to facilitate the description of the embodiments of the present application. Obviously, the accompanying drawings described below are only part of the embodiments of the present application. For those skilled in the art, the accompanying drawings of other embodiments can still be obtained according to the structures illustrated in the accompanying drawings.

FIG. 1 is a schematic structural view of a coaxial fiber according to an embodiment.

FIG. 2 is a TEM image of a coaxial fiber having a diameter of about 800 nm.

FIG. 3 is a schematic structural view of a core fiber according to an embodiment.

FIG. 4 shows a scanning electron micrograph of a coaxial fiber before swelling.

FIG. 5 shows a scanning electron micrograph of a coaxial fiber after swelling.

FIG. 6 shows an electrode coated with a separation layer on a single side according to an embodiment.

FIG. 7 shows an electrode coated with a separation layer on double sides according to an embodiment.

FIG. 8 shows a structure of an electrochemical device according to an embodiment.

FIG. 9 shows an electrode including a conductive coating according to an embodiment.

FIG. 10 shows a structure of an electrochemical device according to an embodiment, wherein the electrochemical device includes a conductive coating.

FIG. 11 shows an electrode coated with an inorganic porous layer according to an embodiment.

FIG. 12 shows a structure of an electrochemical device according to an embodiment, wherein the electrochemical device includes an inorganic porous layer.

### DETAILED DESCRIPTION

Embodiments of the present application are described in detail below. Throughout the specification, the same or similar components and components having the same or similar functions are denoted by similar reference numerals. The embodiments described herein with respect to the accompanying drawings are illustrative and graphical, and are used for providing a basic understanding on the present application. The embodiments of the present application should not be construed as limiting the present application.

As used herein, the terms “substantially,” “generally,” “essentially” and “about” are used to describe and explain small variations. When being used in combination with an event or circumstance, the term may refer to an example in which the event or circumstance occurs precisely, and an example in which the event or circumstance occurs approximately. For example, when being used in combination with a value, the term may refer to a variation range of less than or equal to ±10% of the value, for example, less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, if the difference value between the two values is less than or equal to ±10% of the average of the values (for example, less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%), then the two values can be considered “generally” the same.

In this specification, unless otherwise specified or limited, the relative terms such as “central,” “longitudinal,” “lateral,” “front,” “rear,” “right,” “left,” “internal,” “external,” “lower,” “higher,” “horizontal,” “vertical,” “higher than,” “lower than,” “above,” “below,” “top” and “bottom,” and their derivatives (e.g. “horizontally,” “downward” and “upward”) should be interpreted as referring to the directions described in the discussion or in the drawings. These relative terms are used for convenience only in the description and are not required to construct or operate the present application in a particular direction.

Further, for convenience of description, “first,” “second,” “third” and the like may be used herein to distinguish different components of one drawing or series of drawings. “First,” “second,” “third” and the like are not intended to describe the corresponding components.

In addition, amounts, ratios and other numerical values are sometimes presented herein in a range format. It should be appreciated that such range formats are for convenience and conciseness, and should be flexibly understood as comprising not only values explicitly specified to range constraints, but also all individual values or sub-ranges within the ranges, like explicitly specifying each value and each sub-range.

In the detailed description and the claims, a list of items connected by the term “at least one of” or similar terms may mean any combination of the listed items. For example, if items A and B are listed, then the phrase “at least one of A and B” means only A; only B; or A and B. In another example, if items A, B and C are listed, then the phrase “at least one of A, B and C” means only A; or only B; only C; A and B (excluding C); A and C (excluding B); B and C (excluding A); or all of A, B and C. The item A may include a single component or multiple components. The item B may include a single component or multiple components. The item C may include a single component or multiple components.

The present application relates to a coaxial fiber and an electrochemical device including the same.

Coaxial Fiber

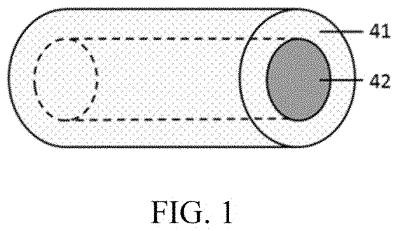

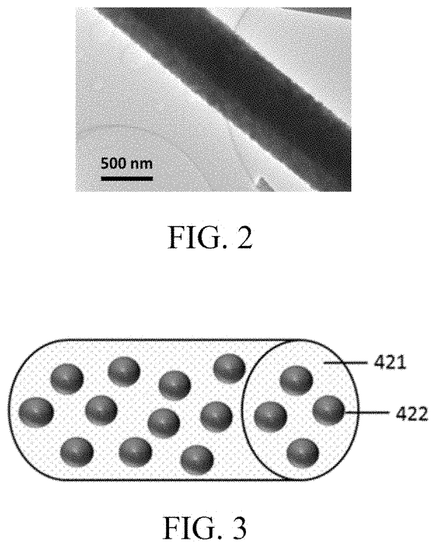

The present application relates to a coaxial fiber which can be used as a separation layer material in an electrochemical device (e.g., a lithium-ion battery). The coaxial fiber may include a first fiber 41 and a second fiber 42 (shown in FIG. 1), the first fiber 41 wrapping the second fiber 42 therein. FIG. 2 is a TEM image of a coaxial fiber having a diameter of about 800 nm.

The coaxial fiber may have a diameter of about 20 nm-about 2 μm. In some embodiments, the coaxial fiber may have a diameter of about 50 nm, about 100 nm, about 200 nm, about 500 nm, about 800 nm, about 1 μm, about 1.5 μm, about 100 nm-about 500 nm, about 500 nm-about 800 nm, about 100 nm-about 1000 nm, about 1 μm-about 2 μm or the like.

The ratio of the diameter of the second fiber 42 to the outside diameter of the first fiber 41 (i.e., the diameter of the coaxial fiber) may be about 0.20 to about 0.99. Taking a lithium-ion battery as an example, if the ratio is too large, the conduction of lithium ions is affected, thereby affecting the cycle performance of the lithium-ion battery. If the ratio is too small, the coaxial fiber swells insufficiently in the case of abuse such as overcharge and high temperature, and it is difficult to isolate the conduction of lithium ions. In some embodiments, the ratio of the diameter of the second fiber 42 to the outside diameter of the first fiber 41 may be about 0.3, about 0.4, about 0.5, about 0.6, about 0.7, about 0.8, about 0.9, about 0.2-about 0.5, about 0.3-about 0.5, about 0.5-about 0.9 or the like.

The first fiber 41 may be a polymer material and used for providing a certain mechanical strength and interfacial adhesion to the electrode, and having a good lithium ion conductivity after being soaked with an electrolytic solution to ensure the transport of lithium ions.

In some embodiments, the first fiber 41 may preferably be a lithium ion conductor material. In some embodiments, the first fiber 41 may be at least one selected from the group consisting of polyvinylidene fluoride (PVDF), polyimide, polyamide, polyacrylonitrile (PAN), polyethylene glycol, polyoxyethylene, polyphenylene oxide (PPO), polypropylene carbonate (PPC), polymethyl methacrylate (PMMA), polyethylene terephthalate (PET), poly(ethylene oxide) (PEO), a vinylidene fluoride-hexafluoropropylene copolymer (PVDF-HFP), a vinylidene fluoride-trifluorochloroethylene copolymer and derivatives thereof

The second fiber 42 may be a foamed material, which undergoes a sharp volume expansion (for example, more than about 10 times) at a high temperature (adjustable at about 100° C-about 220° C.), and the pores in the original separation layer may be completely filled, so that the expanded foamed material forms a lithium-ion barrier layer on the surface of the electrode, which generates an effect similar to the closed pore effect of the conventional separator, thereby preventing the electrochemical reaction from continuing, isolating the internal heat source from the source, preventing further increase in temperature, and enhancing the overcharge resistance and abuse resistance. As shown in FIG. 3, the second fiber 42 may include a thermoplastic 421 on the outside and a hydrocarbon 422 having a boiling point of lower than 250° C. on the inside (or surface).

The thermoplastic 421 has stable chemical properties, a certain deformability, and good ion and electron insulation capabilities. In addition, the thermoplastic 421 does not react or swell with the electrolytic solution or the hydrocarbon having a boiling point of lower than 250° C. within about 220° C., and has good mechanical strength within about 220° C., thereby isolating the electrolytic solution from contacting with the hydrocarbon 422 having a boiling point of lower than 250° C. on the inside, and also preventing the hydrocarbon 422 having a boiling point of lower than 250° C. on the inside from being dissolved or escaping into the electrolytic solution.

The hydrocarbon 422 having a boiling point of lower than 250° C. will rapidly vaporize at a high temperature (about 100° C. to about 220° C.) to produce a volume expansion of about 10 times or more, thereby promoting the outside thermoplastic to expand rapidly, and further resulting in diameter swelling of the coaxial fiber. Since the diameter of the coaxial fiber in the separation layer swells, the pores in the separation layer are filled and the surface of the electrode is completely covered, thereby isolating the transport path of lithium ions and preventing the internal heat generation reaction from proceeding.

In some embodiments, the thermoplastic 421 may be at least one selected from the group consisting of polyethylene terephthalate, polybutylene terephthalate (PBT), polyethylene naphthalate, polyimide (PI), polyamide (PA), polyetheretherketone (PEEK), polymethacrylonitrile and polymethyl methacrylate.

In some embodiments, the hydrocarbon 422 having a boiling point of lower than 250° C. may be at least one selected from the group consisting of dibromomethane, ethylene carbonate, p-xylene, dimethylformamide and aniline

In some embodiments, the hydrocarbon 422 having a boiling point of lower than 250° C. is dispersed inside or on the surface of the thermoplastic 421 in the form of particles, and the shape of the particles may be any shape such as a spherical shape, an ellipsoidal shape, a rod shape or an irregular polyhedron.

In some embodiments, the coaxial fiber may be formed by electrospinning, jet spinning, melt spinning, centrifugal spinning or the like. The structure of the coaxial fiber may be realized by nesting the inner and outer needles with each other and simultaneously ejecting the inner and outer solutions.

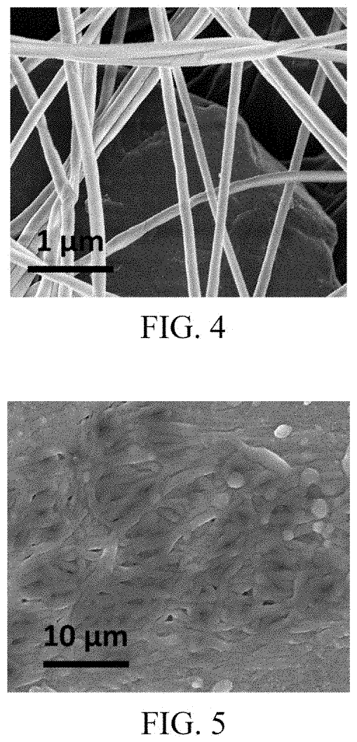

FIG. 4 and FIG. 5 show scanning electron micrographs of the coaxial fiber before and after swelling respectively. As shown in FIG. 4, the coaxial fiber having a diameter of about 200 nm has larger pores before the diameter swells. However, as shown in FIG. 5, when the diameter of the coaxial fiber swells from about 200 nm, the pores of the coaxial fiber are filled and the pores are substantially eliminated. Therefore, the above-mentioned coaxial fiber is used as the separation layer material in the lithium-ion battery, so that the separation layer has the characteristics of closed cells at a high temperature, thereby having better overcharge resistance and abuse resistance.

Electrochemical Device

The present application also relates to an electrochemical device, which may include a cathode, an anode and a separation layer arranged between the cathode and the anode, wherein the separation layer includes the above coaxial fiber. At least one surface of the cathode and the anode may be in contact with the separation layer. For example, the electrochemical device may be a lithium-ion battery, and the separation layer includes the coaxial fiber material and is formed on the surface of the cathode or the anode.

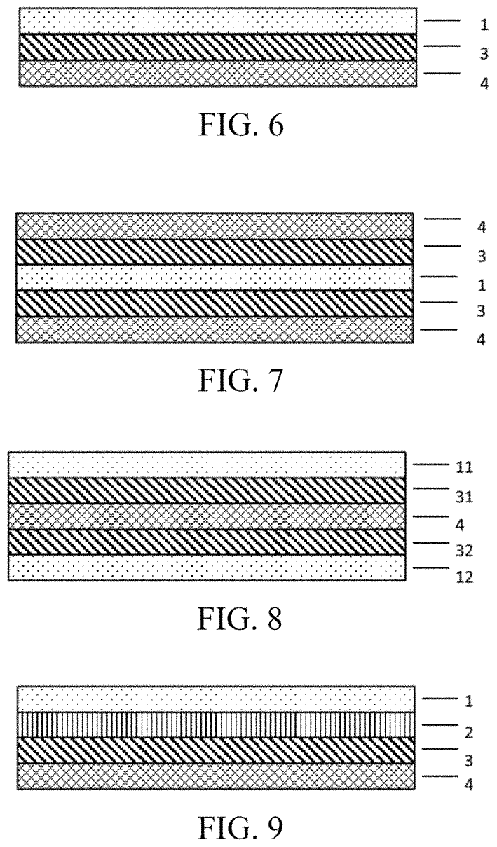

In some embodiments, the separation layer including the coaxial fiber can be coated on a single side or on double sides of the electrode of the electrochemical device. FIG. 6 shows an electrode coated with a separation layer on a single side according to an embodiment, and the electrode may be a cathode or an anode of an electrochemical device. The electrode may include a current collector 1 and an active material layer 3, the active material layer 3 is coated on the surface of the current collector 1, and the separation layer 4 is coated on the surface of the active material layer 3. FIG. 7 shows an electrode coated with a separation layer on double sides according to an embodiment, wherein the active material layer 3 is coated on double sides of the current collector 1, and the separation layer 4 is coated on the surface of the active material layer 3.

FIG. 8 shows the structure of an electrochemical device according to an embodiment. As shown in FIG. 8, the electrochemical device may include a cathode current collector 11, a cathode active material layer 31, a separation layer 4, an anode active material layer 32 and an anode current collector 12. The separation layer 4 may be coated on the cathode active material layer 31, or coated on the anode active material layer 32, or coated both on the cathode active material layer 31 and the anode active material layer 32.

In some embodiments, the separation layer may have a porosity of about 30%-about 95%. In some embodiments, the separation layer has a porosity of about 40%, about 50%, about 60%, about 70%, about 80%, about 90%, about 30% to about 40%, about 30% to about 50%, about 30% to about 60%, about 30%-about 70%, about 30%-about 80%, about 40%-about 50%, about 50%-about 90%, or the like. Taking a lithium-ion battery as an example, if the porosity of the separation layer is too small, the lithium ion transport path is blocked, and the cycle performance of the lithium-ion battery is lowered; and if the porosity of the separation layer is too large, the structure is unstable, the mechanical strength is too poor, and it is impossible to resist the puncture of the particles on the surface of the electrode.

In some embodiments, the separation layer may have the thickness of about 1 μm-about 20 μm. In some embodiments, the separation layer may have the thickness of about 2 μm, about 5 μm, about 10 μm, about 15 μm, about 1 μm-about 5 μm, about 1 μm-about 10 μm, about 2 μm-about 5 μm, about 2 μm-about 10 μm, about 5 μm-about 10 μm, about 10 μm-about 20 μm, about 5 μm-about 15 μm or the like.

In some embodiments, the separation layer may be formed by electrospinning, jet spinning, melt spinning, centrifugal spinning or the like.

In some embodiments, the separation layer may be formed by electrospinning, jet spinning, melt spinning, centrifugal spinning or the like. The jet spinning has a preparation rate of about 10 times that of electrospinning, and has a distinct advantage especially in the preparation of large-diameter fibers. In some embodiments, the separation layer may be formed by electrospinning and jet spinning, thereby further increasing the production rate.

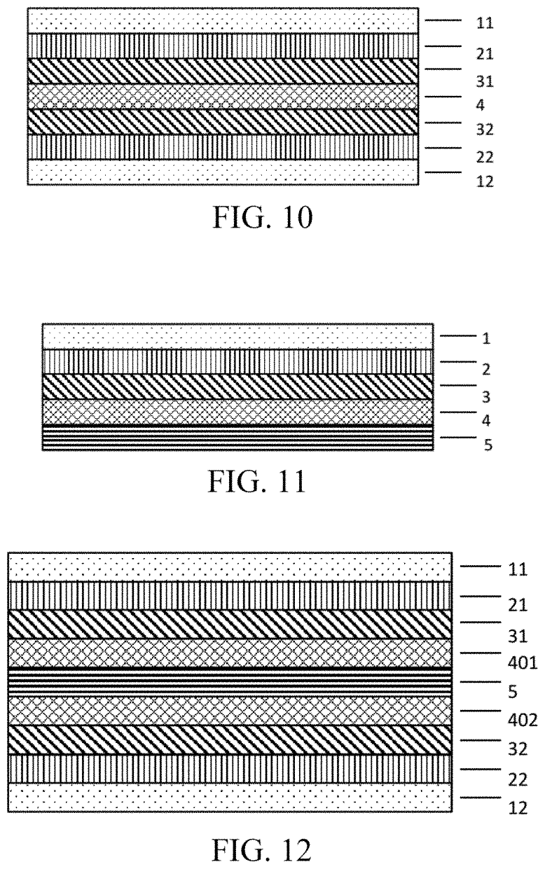

In some embodiments, the electrode of the electrochemical device may include a conductive coating. The conductive coating may be arranged between the current collector and the active material layer, and the conductive coating has good electrical conductivity and at the same time enhances the adhesion between the current collector and the active material layer. FIG. 9 shows an electrode including a conductive coating according to an embodiment, wherein the electrode may be a cathode or an anode. As shown in FIG. 9, the electrode may include a current collector 1, a conductive coating 2 and an active material layer 3, and the conductive coating 2, the active material layer 3 and the separation layer 4 are sequentially coated on the surface of the current collector 1. FIG. 10 shows the structure of an electrochemical device according to an embodiment, wherein the electrochemical device may include a cathode current collector 11, a cathode conductive coating 21, a cathode active material layer 31, a separation layer 4, an anode active material 32, an anode conductive coating 22 and an anode current collector 12. The separation layer 4 may be coated on the cathode active material layer 31, or coated on the anode active material layer 32, or coated on the cathode active material layer 31 and the anode active material layer 32.

In some embodiments, the conductive coating may include a conductive agent and a binder, the conductive agent may be at least one selected from the group consisting of carbon nanotubes, Ketjen black, acetylene black, conductive carbon or graphene, and the binder may be at least one selected from the group consisting of polyamide, polyurethane, an ethylene-vinyl acetate copolymer, an ethylene-vinyl alcohol copolymer, acrylate or polyvinylidene fluoride.

In some embodiments, an inorganic porous layer may be coated on the separation layer of the electrochemical device. FIG. 11 shows an electrode coated with an inorganic porous layer according to an embodiment, wherein the electrode may be a cathode or an anode of an electrochemical device. As shown in FIG. 11, a conductive coating 2, an active material layer 3, a separation layer 4 and an inorganic porous layer 5 are sequentially coated on the surface of a current collector 1, and the electrode includes the current collector 1, the conductive coating 2 and the active material layer 3. According to the embodiment, the conductive coating 2, the active material layer 3, the separation layer 4 and the inorganic porous layer 5 may be sequentially coated on double side surfaces of the current collector 1. FIG. 12 shows an electrochemical device according to an embodiment, wherein the electrochemical device includes the inorganic porous layer. As shown in FIG. 12, the electrochemical device may include a cathode current collector 11, a cathode conductive coating 21, a cathode active material layer 31, a cathode separation layer 401, an inorganic porous layer 5, an anode separation layer 402, an anode active material 32, an anode conductive coating 22 and an anode current collector 12. The positional relationship of each layer is as shown in FIG. 12.

The inorganic porous layer may have a certain mechanical strength and has the ability of electron insulation, so that the mechanical strength can be further improved and the insulating property can be ensured. The inorganic porous layer may be formed inside or on the surface of the separation layer. The inorganic porous layer may be formed in the inner gaps of the different fiber layers of the separation layer, formed between different fiber layers, or formed on the outer surface of the separation layer.

In some embodiments, the inorganic porous layer may include inorganic particles. The inorganic particles are at least one selected from the group consisting of: (a) inorganic particles having a dielectric constant of 5 or more; (b) inorganic particles having piezoelectricity; and (c) inorganic particles having lithium ion conductivity.

In some embodiments, the inorganic particles are the inorganic particles having the dielectric constant of 5 or more; the inorganic particles include at least one selected from the group consisting of BaO, SiO₂, SrTiO₃, SnO₂, CeO₂, MgO, NiO, CaO, ZnO, ZrO₂, Y₂O₃, Al₂O₃, TiO₂, boehmite, magnesium hydroxide, aluminum hydroxide, and SiC.

In some embodiments, the inorganic particles are the inorganic particles having piezoelectricity; the inorganic particles include at least one selected from the group consisting of BaTiO₃, Pb(Zr,Ti)O₃, Pb₁₋ₓLaₓZr_{1-y}TiyO₃ (0<x<1 and 0<y<1), Pb(Mg_{1/3}Nb_{2/3})O₃—PbTiO₃, and hafnium oxide.

In some embodiments, the inorganic particles are the inorganic particles having lithium ion conductivity; the inorganic particles include at least one selected from the group consisting of: lithium phosphate Li₃PO₄; lithium titanium phosphate LiₓTi_{y}(PO₄)₃, wherein 0<x<2 and 0<y<3; lithium aluminum titanium phosphate LiₓAl_{y}Ti_{z}(PO₄)₃, wherein 0<x<2, 0<y<1, and 0<z<3; Li_{1+x+y}(Al, Ga)ₓ(Ti,Ge)₂₋ₓSi_{y}P_{3-y}O₁₂, wherein 0≤x≤1 and 0≤y≤1; (LiAlTiP)ₓO_{y} type glass, wherein 0<x<4 and 0<y<13; lithium lanthanum titanate LₓLa_{y}TiO₃, wherein 0<x<2 and 0<y<3; lithium germanium thiophosphate LiₓGe_{y}P_{z}S_{w}, wherein 0<x<4, 0<y<1, 0<z<1, and 0<w<5; lithium nitride LiₓN_{y}, wherein 0<x<4 and 0<y<2; SiS₂ type glass LiₓSi_{y}S_{z}, wherein 0<x<3, 0<y<2, and 0<z<4; and P₂S₅ type glass LiₓP_{y}S_{z}, wherein 0<x<3, 0<y<3, and 0<z<7. In some embodiments, the inorganic particles having lithium ion conductivity may also be at least one selected from the group consisting of: Li₂O, LiF, LiOH, Li₂CO₃, LiAlO₂, Li₂O—Al₂O₃—SiO₂—P₂O₅—TiO₂—GeO₂ ceramic or garnet ceramic (Li₃₋₁La₃M₂O₁₂, wherein 0≤x≤5, and M is Te, Nb or Zr).

In some embodiments, the inorganic porous layer may have a thickness of about 0.1 μm-about 20 μm. If the thickness of the inorganic porous layer is too small, the effect of enhancing the mechanical strength cannot be exerted, and the effect of suppressing particle piercing and lithium dendrite growth cannot be effectively achieved. If the thickness of the inorganic porous layer is too large, lithium ion conduction is suppressed, and the polarization of the lithium-ion battery is increased, thereby affecting the performance of the lithium-ion battery. In some embodiments, the inorganic porous layer may have the thickness of about 0.1 μm, about 0.5 μm, about 1 μm, about 5 μm, about 10 μm, about 15 μm, about 0.1 μm-about 1 μm, about 1 μm-about 5 μm, about 5 μm-about 10 μm , about 1 μm-about 10 μm, about 5 μm-about 15 μm, about 10 μm-about 20 μm or the like.

In some embodiments, the inorganic porous layer may have a porosity of about 10%-about 40%. In some embodiments, the inorganic porous layer may have a porosity of about 10%, about 15%, about 20%, about 25%, about 30%, about 35%, about 10%-about 20%, about 10%-about 30% or the like.

In some embodiments, the inorganic porous layer may have an average pore size of about 0.1 μm-about 1μm, for example, about 0.1 μm-about 0.5 μm or about 0.5 μm-about 1 μm.

In some embodiments, the inorganic porous layer has an electronic resistivity of greater than about 10⁷ Ωm. In some embodiments, the inorganic porous layer has an electronic resistivity of greater than about 10¹⁰ Ωm.

In some embodiments, the inorganic porous layer has an ionic conductivity of about 10⁻⁸ S/cm-about 10⁻² S/cm. In some embodiments, the inorganic porous layer has an ionic conductivity of about 10⁻⁸ S/cm-about 10⁻⁵ S/cm, about 10⁻⁷ S/cm-about 10⁻⁵ S/cm, about 10⁻⁶ S/cm-about 10⁻⁵ S/cm, about 10⁻⁵ S/cm-about 10⁻⁴ S/cm, about 10⁻⁵ S/cm-about 10⁻³ S/cm, about 10⁻⁵ S/cm-about 10⁻² S/cm, about 10⁻³ S/cm-about 10⁻² S/cm or the like.

The inorganic porous layer and the separation layer may be bonded by using a hot pressing method or an adhesion method. When the hot pressing method is used, the pressure may be about 0.1 MPa-about 1 MPa. When the adhesion method is used, the binder may be at least one selected from the group consisting of: polyamide, polyurethane, an ethylene-vinyl acetate copolymer (EVA), an ethylene-vinyl alcohol copolymer (EVOH), acrylate or polyvinylidene fluoride. In addition, if the inorganic porous layer is directly deposited or coated on the separation layer, the inorganic porous layer and the separation layer can be naturally bonded without a binder.

When the inorganic porous layer is formed on the surface of the separation layer, a part of the inorganic porous layer may be inserted into the pores of the separation layer to provide a certain fixing effect and further enhance the overall mechanical strength. In some embodiments, the inorganic porous layer is inserted into the separation layer at a depth of about 0.1 μm-20 μm. In some embodiments, the inorganic porous layer is inserted into the separation layer at a depth of about 0.5 μm, about 1 μm, about 5 μm, about 10 μm, about 0.1 μm-about 0.5 μm, about 0.5 μm-about 1 μm, about 0.5 μm-about 5 μm, about 1 μm-about 5μm, about 1 μm-about 10 μm, about 5 μm-about 20 μm or the like.

In some embodiments, the separation layer may include inorganic particles as described above, i.e., the above inorganic particles may be formed directly inside the separation layer.

According to embodiments of the present application, a separation layer is provided on the surface of the electrode of the electrochemical device, and the separation layer includes the coaxial fiber. The shell of the coaxial fiber may be a polymer material, and may provide an ion conduction path; and the core of the coaxial fiber may be a foamed material, which undergoes a sharp volume expansion at a high temperature, thereby blocking the lithium ion transport path and enhancing the safety of the electrochemical device.

According to embodiments of the present application, the separation layer including the coaxial fiber can be used for preparing a lithium-ion battery, so that the thickness of the separation layer can be reduced, and the separation layer has excellent overcharge and abuse resistance and excellent safety performance. In addition, the lithium-ion battery has good chemical stability.

The electrochemical device may be a lithium-ion battery. The lithium-ion battery includes a cathode containing a cathode active material layer, an anode containing an anode active material layer, an electrolyte, and a separation layer between the cathode and the anode. The cathode current collector may be aluminum foil or nickel foil, and the anode current collector may be copper foil or nickel foil.

In the above lithium-ion battery, the cathode active material layer includes a cathode material capable of absorbing and releasing lithium (Li) (hereinafter, sometimes referred to as “a cathode material capable of absorbing/releasing lithium Li”). Examples of the cathode material capable of absorbing/releasing lithium (Li) may include at least one of lithium cobalt oxide, lithium nickel cobalt manganese oxide, lithium nickel cobalt aluminum oxide, lithium manganese oxide, lithium manganese iron phosphate, lithium vanadium phosphate, lithium vanadyl phosphate, lithium iron phosphate, lithium titanium oxide or lithium-rich manganese-based materials.

In the above cathode material, the chemical formula of lithium cobalt oxide can be LiₓCoₐM1_{b}O_{2-c}, where M1 is at least one selected from the group consisting of nickel (Ni), manganese (Mn), magnesium (Mg), aluminum (Al), boron (B), titanium (Ti), vanadium (V), chromium (Cr), iron (Fe), cuprum (Cu), zinc (Zn), molybdenum (Mo), tin (Sn), calcium (Ca), strontium (Sr), wolfram (W), yttrium (Y), lanthanum (La), zirconium (Zr), and silicon (Si), and the values of x, a, b and c are respectively in the following ranges: 0.8≤x≤1.2, 0.8≤a≤1, 0≤b≤0.2 and −0.1≤c≤0.2.

In the above cathode material, the chemical formula of the lithium nickel cobalt manganese oxide or lithium nickel cobalt aluminum oxide can be Li_{y}Ni_{d}M2ₑO_{2-f}, wherein M2 denotes at least one selected from the group consisting of cobalt (Co), manganese (Mn), magnesium (Mg), aluminum (Al), boron (B), titanium (Ti), vanadium (V), chromium (Cr), iron (Fe), cuprum (Cu), zinc (Zn), molybdenum (Mo), tin (Sn), calcium (Ca), strontium (Sr), wolfram (W), zirconium (Zr) or silicon (Si), and the values of y, d, e and f are respectively in the following ranges: 0.8≤y ≤1.2, 0.3≤d≤0.98, 0.02≤e≤0.7, and −0.1≤f≤0.2.

In the above cathode material, the chemical formula of lithium manganese oxide can be Li_{z}Mn_{2-g}M3_{g}O₄₋ₕ, wherein M3 is at least one selected from the group consisting of cobalt (Co), nickel (Ni), magnesium (Mg), aluminum (Al), boron (B), titanium (Ti), vanadium (V), chromium (Cr), iron (Fe), cuprum (Cu), zinc (Zn), molybdenum (Mo), tin (Sn), calcium (Ca), strontium (Sr) or wolfram (W), and the values of z, g and h are respectively in the following ranges: 0.8≤z≤1.2, 0≤g≤1.0 and −0.2≤h≤0.2.

The anode active material layer includes a anode material capable of absorbing and releasing lithium (Li) (hereinafter, sometimes referred to as “an anode material capable of absorbing/releasing lithium Li”). Examples of the anode material capable of absorbing/releasing lithium (Li) may include a carbon material, a metal compound, an oxide, a sulfide, a nitride of lithium such as LiN₃, a lithium metal, a metal forming an alloy with lithium, and a polymer material.

Examples of the carbon material may include low graphitized carbon, easily graphitized carbon, artificial graphite, natural graphite, mesocarbon microbeads, soft carbon, hard carbon, pyrolytic carbon, coke, vitreous carbon, an organic polymer compound sintered body, carbon fibers and active carbon. The coke may include pitch coke, needle coke and petroleum coke. The organic polymer compound sintered body refers to a material obtained by calcining a polymer material such as phenol plastic or furan resin at an appropriate temperature to carbonize the polymer material, and some of these materials are classified into low graphitized carbon or easily graphitized carbon. Examples of the polymer material may include polyacetylene and polypyrrole.

Among these anode materials capable of absorbing/releasing lithium (Li), materials of which the charging and discharging voltages are close to the charging and discharging voltages of the lithium metal are selected. This is because if the charging and discharging voltages of the anode material are lower, the lithium-ion battery has higher energy density more easily. The anode material can be selected from carbon materials because the crystal structures of the carbon materials are only slightly changed upon charging and discharging, so good cycle characteristics and large charging and discharging capacities can be obtained. For example, graphite is selected because the graphite can give a large electrochemical equivalent and a high energy density.

Further, the anode material capable of absorbing/releasing lithium (Li) may include elemental lithium metal, metal elements and semi-metal elements capable of forming alloys together with lithium (Li), alloys and compounds including such elements. For example, the anode material is used together with a carbon material, in which case good cycle characteristics as well as high energy density can be obtained. In addition to the alloys including two or more metal elements, the alloys used here also include alloys including one or more metal elements and one or more semi-metal elements. The alloys can be in the form of a solid solution, a eutectic crystal, an intermetallic compound and a mixture thereof.

Examples of the metal elements and the semimetal elements may include tin (Sn), lead (Pb), aluminum (Al), indium (In), silicon (Si), zinc (Zn), stibium (Sb), bismuth (Bi), cadmium (Cd), magnesium (Mg), boron (B), gallium (Ga), germanium (Ge), arsenic (As), silver (Ag), zirconium (Zr), yttrium (Y) and hafnium (Hf). Examples of the above alloys and compounds may include a material having a chemical formula: MaₛMbₜLiᵤ and a material having a chemical formula: MaₚMc_{q}Mdᵣ. In these chemical formulas, Ma denotes at least one of the metal elements and the semi-metal elements capable of forming an alloy together with lithium; Mb denotes at least one of the metal elements and the semi-metal elements except lithium and Ma; Mc denotes at least one of non-metal elements; Md denotes at least one of the metal elements and the semi-metal elements except Ma; and s, t, u, p, q and r satisfy s>0, t≥0, u≥0, p>0, q>0, and r≥0.

In addition, an inorganic compound not including lithium (Li), such as MnO₂, V₂O₅, V₆O₁₃, NiS or MoS, may be used in the anode.

The above lithium-ion battery further includes an electrolyte, the electrolyte can be one or more of a gel electrolyte, a solid electrolyte and an electrolytic solution, and the electrolytic solution includes a lithium salt and a non-aqueous solvent.

The lithium salt is one or more selected from the group consisting of LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiSiF₆, LiBOB or lithium difluoroborate. For example, LiPF₆ is selected as the lithium salt because LiPF₆ can give high ionic conductivity and improve cycle characteristics.

The non-aqueous solvent may be a carbonate compound, a carboxylate compound, an ether compound, other organic solvents and a combination thereof.

The carbonate compound may be a chain carbonate compound, a cyclic carbonate compound, a fluorocarbonate compound and a combination thereof.

Examples of the chain carbonate compound are diethyl carbonate (DEC), dimethyl carbonate (DMC), dipropyl carbonate (DPC), methylpropyl carbonate (MPC), ethylpropyl carbonate (EPC), methylethyl carbonate (MEC) and a combination thereof. Examples of the cyclic carbonate compound are ethylene carbonate (EC), propylene carbonate (PC), butylene carbonate (BC), vinyl ethylene carbonate (VEC) and a combination thereof. Examples of the fluorocarbonate compound are fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, trifluoromethylethylene carbonate and a combination thereof.

Examples of the carboxylate compound are methyl acetate, ethyl acetate, n-propyl acetate, tert-butyl acetate, methyl propionate, ethyl propionate, propyl propionate, γ-butyrolactone, decalactone, valerolactone, mevalonolactone, caprolactone, methyl formate and a combination thereof.

Examples of the ether compound are dibutyl ether, tetraethylene glycol dimethyl ether, diglyme, 1,2-dimethoxyethane, 1,2-diethoxyethane, ethoxymethoxyethane, 2-methyltetrahydrofuran, tetrahydrofuran and a combination thereof.

Examples of other organic solvents are dimethyl sulfoxide, 1,2-dioxolane, sulfolane, methyl sulfolane, 1,3-dimethyl-2-imidazolidinone, N-methyl-2-pyrrolidone, formamide, dimethylformamide, acetonitrile, trimethyl phosphate, triethyl phosphate, trioctyl phosphate, phosphate and a combination thereof

Hereinafter, a lithium-ion battery is taken as an example, and combined with specific preparation methods and tests on the prepared lithium-ion battery to explain the preparation and performance of the lithium-ion battery of the present application. However, those skilled in the art will appreciate that the preparation methods described in the present application are merely examples, and that any other suitable preparation method is within the scope of the present application.

### EMBODIMENTS

### Embodiment 1

(1) Preparation of Anode

An anode active material, i.e., graphite, conductive carbon black, and styrene-butadiene rubber were mixed according to a weight ratio of 96:1.5:2.5, deionized water was added as a solvent to prepare a slurry having a solid content of 0.7, and the mixture was uniformly stirred. The slurry was uniformly coated on an anode current collector copper foil and dried at 110° C. to obtain the anode. After the coating was completed, the anode was cut into a size of 41 mm×61 mm for use.

The coaxial fiber was prepared by electrospinning on the surface of the anode as follows:

1) 1 g of polyvinylidene fluoride was dissolved in a mixed solvent of N,N-dimethylformamide and acetone (volume ratio of 4:6) to obtain an 8 wt % polymer solution 1;

2) 0.2 g of dibromomethane and 0.7 g of polyethylene terephthalate were dispersed in tetrahydrofuran to obtain a 10 wt % polymer solution 2;

3) by using a coaxial spinning device, the above two polymer solutions were simultaneously injected, wherein the solution 1 at the shell and the solution 2 at the core were both maintained an injection speed of 0.02 mL/min, and the two solutions were ensured to be in a continuous magnetic stirring state before the injection;

4) the injected coaxial fiber was directly collected on the surface of the anode, and dried at a temperature of about 70° C. for 12 h, thereby preparing the separation layer having the thickness of 2.5 μm and a coaxial fiber diameter (or shell fiber diameter) of 20 nm.

The separation layer had a porosity of 80%. The material of the shell fiber is (such as the first fiber 41 in FIG. 1) was polyvinylidene fluoride, and the material of the thermoplastic (such as the thermoplastic 421 in FIG. 4) in the core foamed material (such as the second fiber 42 in FIG. 1) was polyethylene terephthalate, the hydrocarbon having a boiling point of lower than 250° C. (such as the hydrocarbon 422 having a boiling point of lower than 250° C. in FIG. 4) was dibromomethane, and the ratio of the diameter of the core fiber to the outside diameter of the shell fiber (i.e., the diameter of the coaxial fiber in the separation layer) was 0.5.

After the above steps were completed, the single-sided coating of the anode was completed. Thereafter, these steps were also completed on the back surface of the electrode in the same manner to obtain a double-sided coated anode.

(2) Preparation of Cathode

A cathode active material, i.e., lithium cobalt oxide, conductive carbon black and polyvinylidene fluoride were mixed according to a weight ratio of 97.5:1.0:1.5, N-methylpyrrolidone was added as a solvent to prepare a slurry having a solid content of 0.75, and the mixture was uniformly stirred. The slurry was uniformly coated on a cathode current collector aluminum foil and dried at 90° C. to obtain the cathode. After the coating was completed, the cathode was cut into a size of 38 mm×58 mm for use.

A separation layer having the thickness of 2.5 μm and a coaxial fiber diameter (or shell fiber diameter) of 20 nm was prepared by electrospinning on the surface of the cathode. The separation layer had a porosity of 80%. The material of the shell fiber was polyvinylidene fluoride, and the material of the thermoplastic in the core foamed material was polyethylene terephthalate, the hydrocarbon having a boiling point of lower than 250° C. was dibromomethane, and the ratio of the diameter of the core fiber to the outside diameter of the shell fiber (i.e., the diameter of the coaxial fiber in the separation layer) was 0.5.

After the above steps were completed, the single-sided coating of the cathode was completed. Thereafter, these steps were also completed on the back surface of the electrode in the same manner to obtain a double-sided coated cathode.

(3) Preparation of Electrolytic Solution

In a dry argon atmosphere, organic solvents ethylene carbonate (EC), ethyl methyl carbonate (EMC) and diethyl carbonate (DEC) were firstly mixed according to a weight ratio of 30:50:20. Then, a lithium salt lithium hexafluorophosphate (LiPF₆) was added to the organic solvents, dissolved and uniformly mixed to obtain an electrolytic solution having a lithium salt concentration of 1.15 mol/L.

(4) Preparation of Lithium-ion Battery

The coated anode and the cathode were opposed and stacked. After the four corners of the entire laminated structure were fixed by a tape, the structure was placed in an aluminum plastic film, and after top side sealing, injection and packaging, the lithium-ion battery (laminated structure) was finally obtained.

The preparation method of Embodiment 2 was the same as the preparation method in Embodiment 1, except that coaxial fibers of the separation layers arranged on the surfaces of the cathode and anode both had the diameter of 200 nm.

The preparation method of Embodiment 3 was the same as the preparation method in Embodiment 1, except that coaxial fibers of the separation layers arranged on the surfaces of the cathode and anode both had the diameter of 500 nm.

The preparation method of Embodiment 4 was the same as the preparation method in Embodiment 1, except that coaxial fibers of the separation layers arranged on the surfaces of the cathode and anode both had the diameters of 2 μm.

The preparation method of Embodiment 5 was the same as the preparation method in Embodiment 1, except that coaxial fibers of the separation layers arranged on the surfaces of the cathode and anode both had the diameter of 200 nm, and the ratio of the diameter of the core fiber to the outside diameter of the shell fiber of 0.2.

The preparation method of Embodiment 6 was the same as the preparation method in Embodiment 1, except that coaxial fibers of the separation layers arranged on the surfaces of the cathode and anode both had the diameter of 200 nm, and the ratio of the diameter of the core fiber to the outside diameter of the shell fiber of 0.4.

The preparation method of Embodiment 7 was the same as the preparation method in Embodiment 1, except that coaxial fibers of the separation layers arranged on the surfaces of the cathode and anode both had the diameter of 200 nm, and the ratio of the diameter of the core fiber to the outside diameter of the shell fiber of 0.6.

The preparation method of Embodiment 8 was the same as the preparation method in Embodiment 1, except that coaxial fibers of the separation layers arranged on the surfaces of the cathode and anode both the diameter of 200 nm, and the ratio of the diameter of the core fiber to the outside diameter of the shell fiber of 0.99.

The preparation method of Embodiment 9 was the same as the preparation method in Embodiment 1, except that coaxial fibers of the separation layers arranged on the surfaces of the cathode and anode both had the diameter of 200 nm, and the ratio of the diameter of the core fiber to the outside diameter of the shell fiber of 0.6, and the separation layers both had the thickness of 0.5 μm.

The preparation method of Embodiment 10 was the same as the preparation method in Embodiment 1, except that coaxial fibers of the separation layers arranged on the surfaces of the cathode and anode both had the diameter of 200 nm, and the ratios of the diameter of the core fiber to the outside diameter of the shell fiber of 0.6, and the separation layers both had the thickness of 5 μm.

The preparation method of Embodiment 11 was the same as the preparation method in Embodiment 1, except that coaxial fibers of the separation layers arranged on the surfaces of the cathode and anode both had the diameter of 200 nm, and the ratio of the diameter of the core fiber of the separation layer fiber to the outside diameter of the shell fiber of 0.6, and the separation layers both had the thickness of 10 μm.

The preparation method of Embodiment 12 was the same as the preparation method in Embodiment 1, except that coaxial fibers of the separation layers arranged on the surfaces of the cathode and anode both had the diameter of 200 nm, and the ratio of the diameter of the core fiber to the outside diameter of the shell fiber of 0.6, and the separation layers both had the thickness of 5 μm and a porosity of 30%.

The preparation method of Embodiment 13 was the same as the preparation method in Embodiment 1, except that coaxial fibers of the separation layers arranged on the surfaces of the cathode and anode both had the diameter of 200 nm, and the ratio of the diameter of the core fiber to the outside diameter of the shell fiber of 0.6, and the separation layers both had the thickness of 5 μm and a porosity of 75%.

The preparation method of Embodiment 14 was the same as the preparation method in Embodiment 1, except that coaxial fibers of the separation layers arranged on the surfaces of the cathode and anode both had the diameter of 200 nm, and the ratio of the diameter of the core fiber to the outside diameter of the shell fiber of 0.6, and the separation layers both had the thickness of 5 μm and a porosity of 95%.

The preparation method of Embodiment 15 was the same as the preparation method in Embodiment 1, except that coaxial fibers of the separation layers arranged on the surfaces of the cathode and anode both had the diameter of 200 nm, the ratio of the diameter of the core fiber to the outside diameter of the shell fiber of 0.6, the separation layers both had the thickness of 5 μm and a porosity of 75%, and the materials of the shell fibers were both polyacrylonitrile.

The preparation method of Embodiment 16 was the same as the preparation method in Embodiment 1, except that coaxial fibers of the separation layers arranged on the surfaces of the cathode and anode both had the diameter of 200 nm, and the ratio of the diameter of the core fiber to the outside diameter of the shell fiber of 0.6, and the separation layers both had the thickness of 5 μm and a porosity of 75%, and the materials of the shell fibers were both poly(ethylene oxide).

The preparation method of Embodiment 17 was the same as the preparation method in Embodiment 1, except that coaxial fibers of the separation layers arranged on the surfaces of the cathode and anode both had the diameter of 200 nm, and the ratio of the diameter of the core fiber to the outside diameter of the shell fiber of 0.6, the separation layers both had the thickness of 5 μm and a porosity of 75%, and the materials of the fibers of the separation layers arranged on the surfaces of the cathode and anode were different. In Embodiment 17, the material of the shell fiber of the separation layer fiber arranged on the surface of the anode was polyvinylidene fluoride, the thermoplastic in the core foamed material was polymethyl methacrylate, and the hydrocarbon having a boiling point of lower than 250° C. was p-xylene. The material of the shell fiber of the separation layer coaxial fiber arranged on the surface of the cathode was polyvinylidene fluoride, the thermoplastic in the core foamed material was polyimide, and the hydrocarbon having a boiling point of lower than 250° C. was p-xylene.

The preparation method of Embodiment 18 was the same as the preparation method in Embodiment 1, except that coaxial fibers of the separation layer arranged on the surfaces of the cathode and anode both had the diameter of 200 nm, and the ratio of the diameter of the core fiber to the outside diameter of the shell fiber of 0.6, and the separation layers both had the thickness of 5 μm and a porosity of 75%. The fibers in the separation layers arranged on the surfaces of the cathode and anode both had the material of the shell fiber being polyvinylidene fluoride, the thermoplastic in the core foamed material being polybutylene terephthalate, and the hydrocarbon having a boiling point of lower than 250° C. being ethylene carbonate.

The preparation method of Embodiment 19 was the same as the preparation method in Embodiment 13, except that a conductive coating was coated on the current collectors. In Embodiment 19, a conductive coating was firstly prepared on an anode current collector copper foil and a cathode current collector aluminum foil respectively, and then a lithium-ion battery was prepared according to the preparation method of Embodiment 13. The method for preparing the anode conductive coating was as follows: conductive carbon black and styrene-butadiene rubber were mixed according to a weight ratio of 95:5, deionized water was added as a solvent to prepare a slurry having a solid content of 0.8, and the mixture was uniformly stirred. The slurry was uniformly coated on an anode current collector copper foil and dried at 110° C. to obtain the anode conductive coating. The method for preparing the cathode conductive coating was as follows: conductive carbon black and styrene-butadiene rubber were mixed according to a weight ratio of 97:3, deionized water was added as a solvent to prepare a slurry having a solid content of 0.85, and the mixture was uniformly stirred. The slurry was uniformly coated on an anode current collector aluminum foil and dried at 110° C. to obtain the cathode conductive coating.

The preparation method of Embodiment 20 was the same as the preparation method in Embodiment 19, except that an inorganic porous layer was arranged on the separation layer on the surface of the anode. The preparation method of the inorganic porous layer was as follows: aluminum oxide (Al₂O₃) as inorganic ceramic particles and polyvinylidene fluoride as a binder were mixed according to a weight ratio of 95:5, N-methylpyrrolidone was added as a solvent to prepare a slurry having a solid content of 0.8, and the slurry was uniformly stirred, uniformly coated on the separation layer, and dried at 90° C. to obtain the inorganic porous layer (inorganic porous layer 5 as shown in FIG. 11). The inorganic porous layer had the thickness of 3 μm, a porosity of 30% and a pore diameter of <1 μm.

The preparation method of Embodiment 21 was the same as the preparation method in Embodiment 20, except that the inorganic ceramic particles were zinc oxide and the binder was polyurethane

The preparation method of Embodiment 22 was the same as the preparation method in Embodiment 20, except that the inorganic porous layer had a porosity of 15%.

The preparation method of Embodiment 23 was the same as the preparation method in Embodiment 20, except that the inorganic porous layer had the thickness of 2 μm.

Comparative Example 1 is a lithium-ion battery which was prepared by using a conventional solid fiber (not a coaxial fiber) to form a separation layer without using the coaxial fiber material according to the present application, and is different from Embodiment 1 in that polyvinylidene fluoride separation layers having the thickness of 2.5 μm, a fiber diameter of 0.5 μm and a porosity of 80% were prepared by jet spinning on the surfaces of the cathode and anode.

Test Methods and Test Results

The lithium-ion batteries prepared in the above embodiments and comparative examples were subjected to a hotbox test, a 10 V/3 C overcharge test and a cycle performance test.

Hotbox test: the lithium-ion battery was allowed to stand in an environment of 25° C.±3° C. for 10 min, charged at a constant current of 0.2 C to 3.0 V, and allowed to stand for 5 min; then the lithium-ion battery was charged at 0.5 C to 4.4 V, and charged at a constant voltage to 0.025 C; the lithium-ion battery was placed in a high temperature furnace, the high temperature furnace was raised to 145° C.±2° C. at a rate of 5° C./min±2° C./min, and maintained for 60 min, the change of the lithium-ion battery in the whole process was observed; and if there was no fire, the lithium-ion battery passed the test.

10 V/3 C overcharge test: the lithium-ion battery was charged at a constant current of 0.5 C to 4.4 V and then charged at a constant voltage to 0.05 C, and the voltage of the lithium-ion battery was tested after full charge; the lithium-ion battery was charged at a current of 3 C to 10 V, and kept at a constant voltage for 8 hours; and the change of the lithium-ion battery in the whole process was observed, if there was smoke, explosion or fire, the test was stopped, and if there was no fire or smoke, the lithium-ion battery passed the test.

Cycle performance test: the lithium-ion battery was charged at a constant current of 0.7 C to 4.4 V, then charged at a constant voltage to 0.025 C, allowed to stand for 5 min, discharged at a direct current of 0.5 C to 3.0 V; and after 5 min of standing and after 50 cycles, the capacity retention rate after 50 cycles was calculated, wherein capacity retention rate=discharge capacity/first discharge capacity.

The test results are shown in Table 1.

TABLE 1

| | | | | Total | Material | Thermoplastic |
|---|---|---|---|---|---|---|
| | Diameter of | Diameter ratio | | thickness of | of shell | material of |
| | shell fiber of | of core fiber | Porosity of | separation | fiber of | core fiber of |
| | separation | to shell fiber | separation | layers on | separation | separation |
| | layer on | of separation | layer on | surfaces of | layer on | layer on |
| | surface of | layer on surface | surface of | anode and | surface of | surface of |
| | anode (nm) | of anode | anode | cathode (μm) | anode | anode |
| Comparative | 500 | — | 80% | 5 | PVDF | — |
| Example 1 | | | | | | |
| Embodiment 1 | 20 | 0.5 | 80% | 5 | PVDF | PET |
| Embodiment 2 | 200 | 0.5 | 80% | 5 | PVDF | PET |
| Embodiment 3 | 500 | 0.5 | 80% | 5 | PVDF | PET |
| Embodiment 4 | 2000 | 0.5 | 80% | 5 | PVDF | PET |
| Embodiment 5 | 200 | 0.2 | 80% | 5 | PVDF | PET |
| Embodiment 6 | 200 | 0.4 | 80% | 5 | PVDF | PET |
| Embodiment 7 | 200 | 0.6 | 80% | 5 | PVDF | PET |
| Embodiment 8 | 200 | 0.99 | 80% | 5 | PVDF | PET |
| Embodiment 9 | 200 | 0.6 | 80% | 1 | PVDF | PET |
| Embodiment 10 | 200 | 0.6 | 80% | 10 | PVDF | PET |
| Embodiment 11 | 200 | 0.6 | 80% | 20 | PVDF | PET |
| Embodiment 12 | 200 | 0.6 | 30% | 10 | PVDF | PET |
| Embodiment 13 | 200 | 0.6 | 75% | 10 | PVDF | PET |
| Embodiment 14 | 200 | 0.6 | 95% | 10 | PVDF | PET |
| Embodiment 15 | 200 | 0.6 | 75% | 10 | PAN | PET |
| Embodiment 16 | 200 | 0.6 | 75% | 10 | PEO | PET |
| Embodiment 17 | 200 | 0.6 | 75% | 10 | PVDF | PMMA |
| Embodiment 18 | 200 | 0.6 | 75% | 10 | PVDF | PBT |
| Embodiment 19 | 200 | 0.6 | 75% | 10 | PVDF | PET |
| Embodiment 20 | 200 | 0.6 | 75% | 10 | PVDF | PET |
| Embodiment 21 | 200 | 0.6 | 75% | 10 | PVDF | PET |
| Embodiment 22 | 200 | 0.6 | 75% | 10 | PVDF | PET |
| Embodiment 23 | 200 | 0.6 | 75% | 10 | PVDF | PET |

| | Material of | | | | | | |
|---|---|---|---|---|---|---|---|
| | hydrocarbon | | | | | | |
| | having boiling | | | | | | |
| | point of lower | | | Thickness | | | |
| | than 250° C. of | Material | Porosity | of | 145° | 10 V | Capacity |
| | core fiber of | of | of | inorganic | C. 1 h | 3 C | retention |
| | separation layer | inorganic | inorganic | porous | hotbox | overcharge | rate after |
| | on surface of | porous | porous | layer | pass | pass | 50 cycles |
| | anode | layer | layer | (μm) | rate | rate | (%) |
| Comparative | — | — | — | — | 0/20 | 1/20 | 93.8% |
| Example 1 | | | | | | | |
| Embodiment 1 | Dibromomethane | — | — | — | 12/20 | 15/20 | 93.7% |
| Embodiment 2 | Dibromomethane | — | — | — | 15/20 | 17/20 | 94.0% |
| Embodiment 3 | Dibromomethane | — | — | — | 14/20 | 17/20 | 94.1% |
| Embodiment 4 | Dibromomethane | — | — | — | 14/20 | 16/20 | 94.2% |
| Embodiment 5 | Dibromomethane | — | — | — | 4/20 | 7/20 | 94.3% |
| Embodiment 6 | Dibromomethane | — | — | — | 14/20 | 15/20 | 94.0% |
| Embodiment 7 | Dibromomethane | — | — | — | 15/20 | 17/20 | 93.8% |
| Embodiment 8 | Dibromomethane | — | — | — | 18/20 | 19/20 | 88.9% |
| Embodiment 9 | Dibromomethane | — | — | — | 3/20 | 5/20 | 95.3% |
| Embodiment 10 | Dibromomethane | — | — | — | 16/20 | 18/20 | 93.4% |
| Embodiment 11 | Dibromomethane | — | — | — | 19/20 | 20/20 | 86.3% |
| Embodiment 12 | Dibromomethane | — | — | — | 20/20 | 20/20 | 77.5% |
| Embodiment 13 | Dibromomethane | — | — | — | 16/20 | 18/20 | 93.2% |
| Embodiment 14 | Dibromomethane | — | — | — | 4/20 | 7/20 | 94.8% |
| Embodiment 15 | Dibromomethane | — | — | — | 16/20 | 18/20 | 93.7% |
| Embodiment 16 | Dibromomethane | — | — | — | 15/20 | 18/20 | 92.6% |
| Embodiment 17 | p-xylene | — | — | — | 12/20 | 15/20 | 93.5% |
| Embodiment 18 | Ethylene | — | — | — | 14/20 | 17/20 | 93.8% |
| | carbonate | | | | | | |
| Embodiment 19 | Dibromomethane | — | — | — | 15/20 | 18/20 | 94.4% |
| Embodiment 20 | Dibromomethane | Al₂O₃ | 30% | 3 | 16/20 | 18/20 | 94.3% |
| Embodiment 21 | Dibromomethane | ZnO₂ | 30% | 3 | 17/20 | 18/20 | 94.1% |
| Embodiment 22 | Dibromomethane | Al₂O₃ | 15% | 3 | 17/20 | 19/20 | 92.0% |
| Embodiment 23 | Dibromomethane | Al₂O₃ | 30% | 2 | 16/20 | 18/20 | 94.7% |

(“—” in Table 1 means not added or not applicable)

According to Table 1, it can be seen that the 145° C. 1 h hotbox pass rate and the 10 V 3 C overcharge pass rate of the lithium-ion batteries of the embodiments were significantly superior to those of Comparative Example 1. This is because the temperature inside the lithium-ion battery increases when the hotbox test and the overcharge test are performed. When the temperature rises to a certain temperature, the foamed material in coaxial fiber material of the separation layer expands sharply, so that the pores of the separation layer are blocked, thereby isolating the lithium ion conduction between the cathode and anode, and preventing the electrochemical reaction from further occurrence. However, a common fiber cannot be deformed at a high temperature, and therefore the separation layer prepared from the conventional fiber (Comparative Example 1) cannot function to isolate lithium ion conduction between the cathode and anode at a high temperature, or prevent the electrochemical reaction from further occurrence.

Therefore, the lithium-ion battery prepared according to the present application has superior overcharge resistance and high temperature resistance compared to the lithium-ion battery in which the separation layer is a common fiber that is formed by directly electrospinning

References to “some embodiments,” “part of embodiments,” “one embodiment,” “another example,” “example,” “specific example” or “part of examples” in the whole specification mean that at least one embodiment or example in the present application comprises specific features, structures, materials or characteristics described in the embodiments or examples. Thus, the descriptions appear throughout the specification, such as “in some embodiments,” “in an embodiment,” “in one embodiment,” “in another example,” “in one example,” “in a specific example” or “an example,” which does not necessarily refer to the same embodiment or example in the present application. Furthermore, the specific features, structures, materials or characteristics in the descriptions can be combined in any suitable manner in one or more embodiments or examples.

Although the illustrative embodiments have been shown and described, it should be understood by those skilled in the art that the above embodiments cannot be interpreted as limiting the present application, and the embodiments can be changed, substituted and modified without departing from the spirit, principle and scope of the present application.

1. A coaxial fiber, comprising a first fiber as a shell and a second fiber as a core, wherein the first fiber comprises a polymer, and the second fiber comprises a foamed material.

2. The coaxial fiber according to claim 1, wherein the foamed material comprises a thermoplastic and a hydrocarbon having a boiling point of lower than 250° C., wherein the thermoplastic is at least one selected from the group consisting of polyethylene terephthalate, polybutylene terephthalate, polyethylene naphthalate, polyimide, polyamide, polyetheretherketone, polymethacrylonitrile and polymethyl methacrylate; and wherein the hydrocarbon having a boiling point of lower than 250° C. is at least one selected from the group consisting of dibromomethane, ethylene carbonate, p-xylene, dimethylformamide and aniline.

3. The coaxial fiber according to claim 1, wherein the polymer is at least one selected from the group consisting of polyvinylidene fluoride, polyimide, polyamide, polyacrylonitrile, polyethylene glycol, polyoxyethylene, polyphenylene oxide, polypropylene carbonate, polymethyl methacrylate, polyethylene terephthalate, poly(ethylene oxide), a vinylidene fluoride-hexafluoropropylene copolymer, a vinylidene fluoride-trifluorochloroethylene copolymer and derivatives thereof.

4. The coaxial fiber according to claim 1, wherein the coaxial fiber has a diameter of 20 nm to 2 and a ratio of a diameter of the second fiber to the diameter of the coaxial fiber is 0.20 to 0.99.

5. The coaxial fiber according to claim 2, wherein the hydrocarbon having a boiling point of lower than 250° C. is dispersed inside or on a surface of the thermoplastic, and the hydrocarbon having a boiling point of lower than 250° C. has a spherical shape, an ellipsoidal shape, a rod shape or an irregular polyhedron.

6. An electrochemical device, comprising:
a cathode,
an anode, and
a separation layer disposed between the cathode and the anode, wherein the separation layer comprises a coaxial fiber,
wherein, the coaxial fiber comprises a first fiber as a shell and a second fiber as a core; wherein the first fiber comprises a polymer, and the second fiber comprises a foamed material.

7. The electrochemical device according to claim 6, wherein at least one surface of the cathode and the anode is in contact with the separation layer.

8. The electrochemical device according to claim 6, wherein the separation layer has a thickness of 1 μm to 20 μm, and the separation layer has a porosity of 30% to 95%.

9. The electrochemical device according to claim 6, wherein the separation layer further comprises inorganic particles; the inorganic particles are at least one selected from the group consisting of (a) inorganic particles having a dielectric constant of 5 or more; (b) inorganic particles having piezoelectricity; and (c) inorganic particles having lithium ion conductivity.

10. The electrochemical device according to claim 6, further comprising an inorganic porous layer provided between the separation layer and the cathode or the anode; wherein, the inorganic porous layer is in contact with the separation layer, and the inorganic porous layer comprises the inorganic particles.

11. The electrochemical device according to claim 10, wherein the inorganic particles are at least one selected from the group consisting of: (a) inorganic particles having a dielectric constant of 5 or more; (b) inorganic particles having piezoelectricity; and (c) inorganic particles having lithium ion conductivity.

12. The electrochemical device according to claim 9 or 11, wherein the inorganic particles are the inorganic particles having the dielectric constant of 5 or more; the inorganic particles comprise at least one selected from the group consisting of BaO, SiO₂, SrTiO₃, SnO₂, CeO₂, MgO, NiO, CaO, ZnO, ZrO₂, Y₂O₃, Al₂O₃, TiO₂, boehmite, magnesium hydroxide, aluminum hydroxide, and SiC.

13. The electrochemical device according to claim 9, wherein the inorganic particles are the inorganic particles having piezoelectricity; the inorganic particles comprise at least one selected from the group consisting of BaTiO₃, Pb(Zr,Ti)O₃, Pb₁₋ₓLaₓZr_{1-y}Ti_{y}O₃ (0<x<1 and 0<y<1), Pb(Mg_{1/3}Nb_{2/3})O₃—PbTiO₃, and hafnium oxide.

14. The electrochemical device according to claim 14, wherein the inorganic particles are the inorganic particles having lithium ion conductivity; the inorganic particles comprise at least one selected from the group consisting of:
lithium phosphate Li₃PO₄; lithium titanium phosphate LiₓTi_{y}(PO₄)₃, wherein 0<x<2 and 0<y<3; lithium aluminum titanium phosphate LiₓAl_{y}Ti_{z}(PO₄)₃, wherein 0<x<2, 0<y<1, and 0<_{z}<3; Li_{1+x+y}(Al, Ga)ₓ(Ti,Ge)₂₋ₓSi_{y}P_{3-y}O₁₂, wherein 0≤x≤1 and 0≤y≤1; (LiAlTiP)ₓO_{y} type glass, wherein 0<x<4 and 0<y<13; lithium lanthanum titanium oxide LiₓLa_{y}TiO₃, wherein 0<x<2 and 0<y<3; lithium germanium thiophosphate LiₓGe_{y}P_{z}S_{w}, wherein 0<x<4, 0<y<1, 0<z<1, and 0<w<5; lithium nitride LiₓN_{y}, wherein 0<x<4 and 0<y<2; SiS₂ type glass LiₓSi_{y}S_{z}, wherein 0<x<3, 0<y<2, and 0<z<4; and P₂S₅ type glass LiₓP_{y}S_{z}, wherein 0<x<3, 0<y<3, and 0<z<7.

15. The electrochemical device according to claim 6, wherein the cathode and the anode each comprise a current collector, at least one surface of the current collector being provided with a conductive coating.

16. The electrochemical device according to claim 6, wherein the foamed material comprises a thermoplastic and a hydrocarbon having a boiling point of lower than 250° C.; wherein the thermoplastic is at least one selected from the group consisting of polyethylene terephthalate, polybutylene terephthalate, polyethylene naphthalate, polyimide, polyamide, polyetheretherketone, polymethacrylonitrile and polymethyl methacrylate.

17. The electrochemical device according to claim 16, wherein the hydrocarbon having a boiling point of lower than 250° C. is at least one selected from the group consisting of dibromomethane, ethylene carbonate, p-xylene, dimethylformamide and aniline.

18. The electrochemical device according to claim 6, wherein the polymer is at least one selected from the group consisting of polyvinylidene fluoride, polyimide, polyamide, polyacrylonitrile, polyethylene glycol, polyoxyethylene, polyphenylene oxide, polypropylene carbonate, polymethyl methacrylate, polyethylene terephthalate, poly(ethylene oxide), a vinylidene fluoride-hexafluoropropylene copolymer, a vinylidene fluoride-trifluorochloroethylene copolymer and derivatives thereof.

19. The electrochemical device according to claim 6, wherein the coaxial fiber has a diameter of 20 nm to 2 μm, and a ratio of a diameter of the second fiber to the diameter of the coaxial fiber is 0.20 to 0.99.

20. The electrochemical device according to claim 16, wherein the hydrocarbon having a boiling point of lower than 250° C. is dispersed inside or on the surface of the thermoplastic, and the hydrocarbon has a spherical shape, an ellipsoidal shape, a rod shape or an irregular polyhedron.
